(19) United States
(12) Patent Application Publication
(10) Pub. No.: US 2013/0317889 A1
(43) Pub. Date: Nov. 28, 2013

(54) METHODS FOR ASSESSING TRANSITION VALUE AND DEVICES THEREOF

(71) Applicant: Infosys Limited, (US)

(72) Inventors: Lakshmi Narasimhan Narayanan, Chennai (IN); Gopichand Agnohotram, Guntur (DT) (IN); Subhadip Bandyopadhyay, Kolkata (IN)

(73) Assignee: Infosys Limited, Bangalore (IN)

(21) Appl. No.: 13/891,884

(22) Filed: May 10, 2013

(30) Foreign Application Priority Data
May 11, 2012 (IN) 1881/CHE/2012

(51) Int. Cl. G06Q 10/06

(52) U.S. Cl. CPC G06Q 10/06375
USPC 705/7.37

(57) ABSTRACT

A method, non-transitory computer readable medium, and apparatus that generates a transition enabler overall score for each of a plurality of transition enablers based on at least one weight values and at least one score associated with each transition enabler. A hierarchical statistical model is generated based at least on the transition enabler overall scores and at least one of transition metric values, transition impact values, a transition context index value, or domain expert information. At least one transition impact value is determined for one or more transition impacts based on the hierarchical statistical model. The at least one transition impact value is output.

This application claims the benefit of Indian Patent Application Filing No. 1881/CHE/2012, filed May 11, 2012, which is hereby incorporated by reference in its entirety.

### FIELD

This technology generally relates to the transitioning of one or more applications of a client organization to a different organization or new service provider and, more particularly, to methods and devices for assessing transition value.

### BACKGROUND

The transition of applications can involve the transfer of management, support, and execution, among other functions, of an entire set of applications within a business function from a client to a new external service provider. The applications that are transferred to the new service provider may include software or information technology (IT) applications and/or applications supporting infrastructure. A transfer or service level agreement (SLA) defining transferred services can be executed between the client organization and the new service provider. The transfer can include services, knowledge transition, people, assets, and other resources. The knowledge transition can include due diligence, transition planning, knowledge transfer from users, such as an incumbent team, to users, such as new team, secondary and primary support, transition closure, and steady state, for example, although other phases of transition can be used. An exemplary transition framework for supporting transition of one or more applications is disclosed in U.S. patent application Ser. No. 12/362,578, the entire disclosure of which is hereby incorporated by reference.

During a transition of a portfolio of applications, the work of maintaining and supporting the applications is gradually handed over to the new service provider until the new service provider takes complete ownership of the maintenance and support of the applications in the steady state phase. An exemplary method and system for generating a transition plan is disclosed in U.S. patent application Ser. No. 12/907,234, the entire disclosure of which is hereby incorporated by reference.

Application maintenance engagements are generally increasing in scope and a typical transition life cycle increasingly requires a relatively large commitment of resources from a client organization and a new service provider. Adding to the complexity, transitions can proceed at the same time across multiple locations and multiple geographies. Accordingly, effective transition of knowledge and services and detailed assessment of applications and current services are essential for transition success and for subsequent transformation and steady state support phases.

However, current methods of defining and articulating transition value delivered by a new service provider, as well as defining transition success, are limited to generic, abstract, and qualitative metrics at the overall program or portfolio level. Additionally, current methods of assessing transition value do not allow for systemic risk assessment and management, consideration of transition context, analysis, verification, or validation of transition progress, or application level transition value analysis. Such deficiencies can lead to mismanagement of the transition including inaccurate transition value determinations and can result in low accuracy of actual value delivered with respect to expected delivered transition value established at that transition outset.

### SUMMARY

A method for assessing transition value includes generating with a transition value assessment computing apparatus a transition enabler overall score for each of a plurality of transition enablers based on at least one weight value and at least one score associated with each transition enabler. A hierarchical statistical model is generated with the transition value assessment computing apparatus based at least on the transition enabler overall scores and at least one of transition metric values, transition impact values, a transition context index value, or domain expert information. At least one transition impact value is determined with the transition value assessment computing apparatus based on the hierarchical statistical model.

The at least one transition impact value is output with the transition value assessment computing apparatus.

An apparatus for assessing transition value includes a processor coupled to a memory and configured to execute programmed instructions stored in the memory including generating a transition enabler overall score for each of a plurality of transition enablers based on at least one weight value and at least one score associated with each transition enabler. A hierarchical statistical model is generated based at least on the transition enabler overall scores and at least one of transition metric values, transition impact values, a transition context index value, or domain expert information. At least one transition impact value is determined based on the hierarchical statistical model. The at least one transition impact value is output.

A non-transitory computer readable having stored thereon instructions for assessing transition value comprising machine executable code which when executed by a processor, causes the processor to perform steps including generating a transition enabler overall score for each of a plurality of transition enablers based on at least one weight value and at least one score associated with each transition enabler. A hierarchical statistical model is generated based at least on the transition enabler overall scores and at least one of transition metric values, transition impact values, a transition context index value, or domain expert information. At least one transition impact value is determined based on the hierarchical statistical model. The at least one transition impact value is output.

This technology provides a number of advantages including a transition value analysis framework for generating quantitative metrics for estimating delivered transition value at the application level. In particular, this technology generates a quantitative assessment of transition impact value(s) for a plurality of transition impacts based on transition context, new service provider capabilities, and historical data for a plurality of efficiency metrics and transition impact values. Additionally, this technology leverages statistical models including relationships of quantitative metrics for new service provider capabilities to transition metric data and of the transition metric data to transition impact value data. Using the statistical models, this technology generates transition impact value(s) from the possible range of transition impact values and compares the transition impact values to client-defined transition goals by using a transition value dashboard.

### BRIEF DESCRIPTION OF THE DRAWINGS

FIG. 1 is a block diagram of a network environment which incorporates an exemplary transition value assessment computing apparatus for assessing transition value;

FIG. 2 is a flowchart of an exemplary method for assessing transition value using metrics, impact, and hierarchical statistical engines; and

FIG. 3 is a flowchart of an exemplary method for assessing transition value using a hierarchical statistical engine.

### DETAILED DESCRIPTION

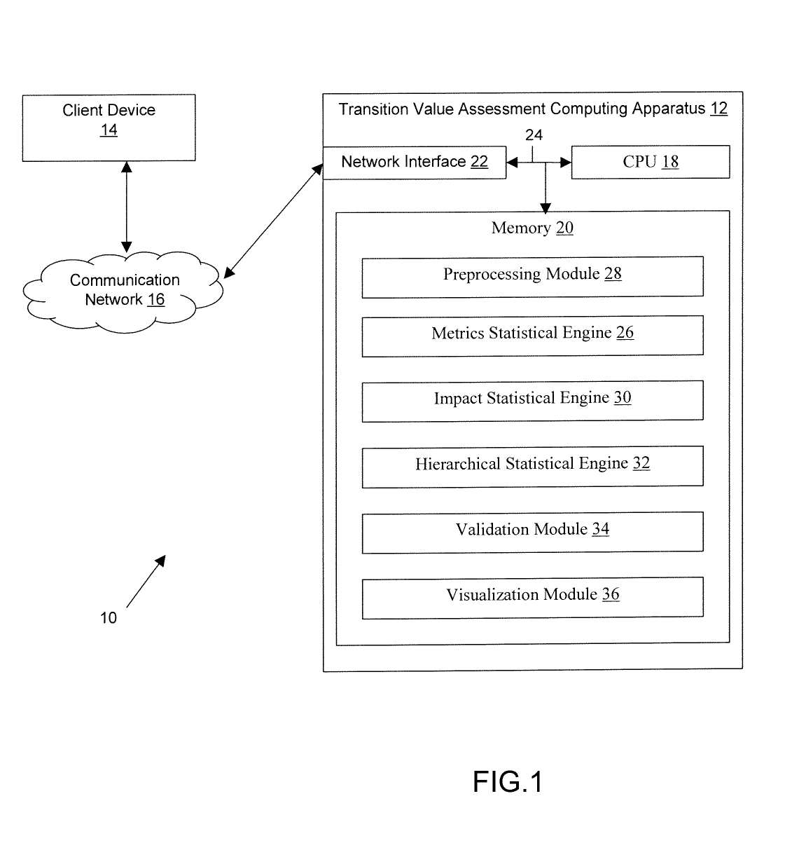

A network environment 10 with an exemplary transition value assessment computing apparatus 12 is illustrated in FIG. 1. The environment 10 includes the transition value assessment computing apparatus 12 and a client computing device 14, coupled together by one or more communication networks 16, although this environment 10 can include other numbers and types of systems, devices, components, and elements in other configurations, such as multiple numbers of each of these apparatuses and devices. This technology provides a number of advantages including methods, non-transitory computer readable medium, and devices that effectively assess application level transition value delivery.

The transition value assessment computing apparatus 12 includes a central processing unit (CPU) or processor 18, a memory 20, and a network interface device 22 which are coupled together by a bus 24 or other link, although other numbers and types of systems, devices, components, and elements in other configurations and locations can be used. The processor 18 in the transition value assessment computing apparatus 12 executes a program of stored instructions for one or more aspects of the present technology as described and illustrated by way of the examples herein, although other types and numbers of processing devices and logic could be used and the processor could execute other numbers and types of programmed instructions.

The memory 20 in the transition value assessment computing apparatus 12 stores these programmed instructions such as in a metrics statistical engine 26, a preprocessing module 28, an impact statistical engine 30, a hierarchical statistical engine 32, a validation module 34, and/or a visualization module 36 for one or more aspects of the present technology as described and illustrated herein. However, some or all of the programmed instructions and database could be stored and/or executed elsewhere such as at the client computing device 14, for example. A variety of different types of memory storage devices, such as a random access memory (RAM) and/or read only memory (ROM) in the transition value assessment computing apparatus 12 or a floppy disk, hard disk, CD ROM, DVD ROM, or other computer readable medium which is read from and written to by a magnetic, optical, or other reading and writing system that is coupled to the processor 18 in the transition value assessment computing apparatus 12, can be used for the memory 20.

In one example, the network interface device 22 of the transition value assessment computing apparatus 12 operatively couples and facilitates communication between the transition value assessment computing apparatus 12 and the client computing device 14 via the communications network 16, although other types and numbers of communication networks or systems with other types and numbers of connections and configurations can be used. By way of example only, the communications network could use TCP/IP over Ethernet and industry-standard protocols, including NFS, CIFS, SOAP, XML, LDAP, and/or SNMP, although other types and numbers of communication networks, such as a direct connection, a local area network, a wide area network, each having their own communications protocols, can be used.

The client computing device can include a central processing unit (CPU) or processor, a memory, a network interface device, and an input and/or display device interface, which are coupled together by a bus or other link, although other numbers and types of network devices could be used. The client computing device may run interface applications that provide an interface to make requests for and send content and/or data to different applications or services provided by the transition value assessment computing apparatus 12 via the communication network 16.

Although examples of the transition value assessment computing apparatus 12 are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples.

The examples may also be embodied as a non-transitory computer readable having instructions stored thereon for one or more aspects of the present technology as described and illustrated by way of the examples herein, as described herein, which when executed by a processor, cause the processor to carry out the steps necessary to implement the methods of the examples, as described and illustrated herein.

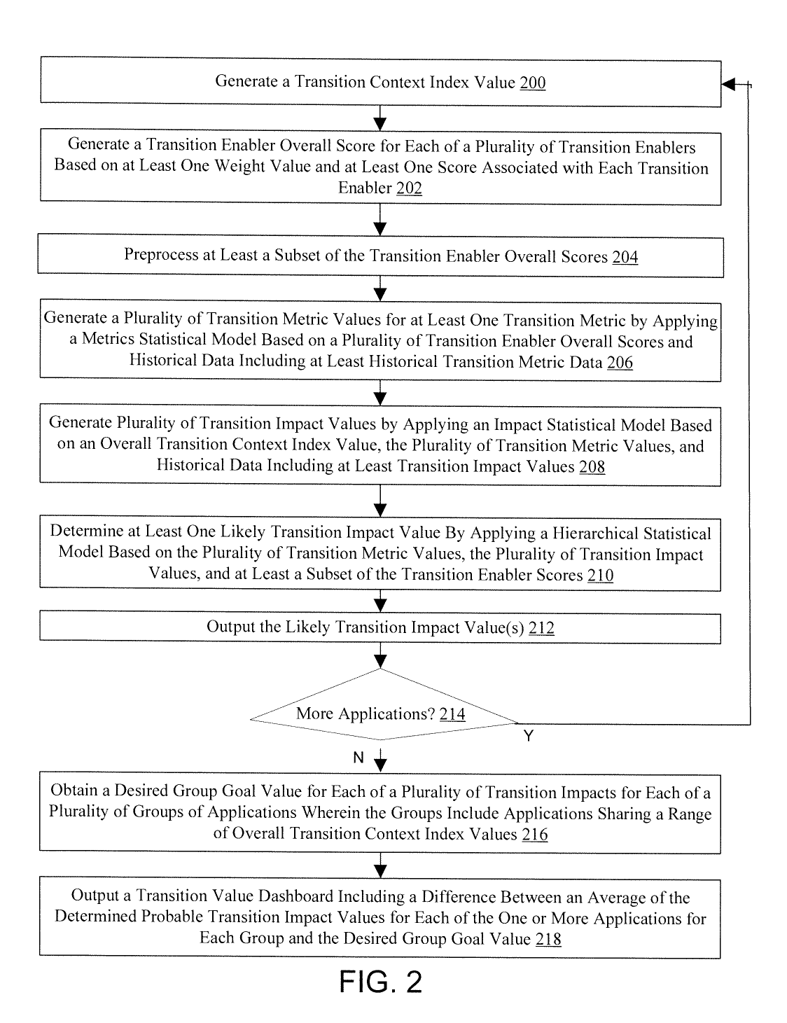

An exemplary method for assessing transition value using metrics, impact, and hierarchical statistical engines will now be described with reference to FIGS. 1-2. In this particular example, in step 200, the transition value assessment computing apparatus 12 generates a transition context index value for at least one application within the scope of the transition based on a plurality of context attribute scores, a plurality of context attribute weights, and a plurality of context dimension weights. Each context attribute score and context attribute weight can be associated with one of a plurality of context attributes, each of which is associated with at least one context dimension. Exemplary transition context dimensions and associated context attributes are shown in Table 1, although other numbers and types of context attributes can be used.

TABLE 1

| | | | | Context | | |
|---|---|---|---|---|---|---|
| | | Context | Context | Dimension | | |
| Context | Context | Attribute | Attribute | Weighted | Overall | Transition context |
| Dimension | Attributes | Weight | Score | score | Weight | Index Value |
| Transition | Source Code | 25% | 8 | 5.5 | 40% | 5.78 |
| Scenarios | status | | | | | |
| | SME status | 25% | 5 | | | |
| | Application | 25% | 6 | | | |
| | Status | | | | | |
| | Document | 25% | 3 | | | |
| | Status | | | | | |
| Engagement | Environment | 30% | 9 | 7.7 | 20% | |
| Characteristics | Service | 30% | 6 | | | |
| | Provider | | | | | |
| | Context | | | | | |
| | Overall | 40% | 8 | | | |
| | Program | | | | | |
| | Risk | | | | | |
| Application | Functional | 30% | 6 | 5.1 | 40% | |
| Characteristics | Complexity | | | | | |
| | and Service | | | | | |
| | Complexity | | | | | |
| | Criticality | 30% | 5 | | | |
| | Stability | 10% | 8 | | | |
| | Application | 10% | 6 | | | |
| | Significance | | | | | |
| | Operations | 20% | 2 | | | |
| | Risk | | | | | |

Each of the context attributes represents a characteristic of the application and each context dimension represents a set of characteristics. Together, the context dimensions represent the context or environment of the application transition. For example, the application status can represent the stability of the application and the SME status can represent the availability during the transition of a subject matter expert (SME) for the application.

In this example, the transition value assessment computing apparatus 12 obtains the context attribute score and the context attribute weight value for each of the context attributes. The context attribute scores and weights can be determined by the new service provider based on data obtained during an interview process at the time of engagement with the client organization, for example. The context attribute weights associated with each context attribute can indicate a relative importance of the context attribute to the context dimension. The context attribute scores can be a relative value on a one to ten scale, for example, and the context attribute weights can be percentage values totaling one hundred percent for each context dimension, although other values and proportions can be used.

In this example, the transition value assessment computing apparatus 12 determines a plurality of context dimension weighted scores based on an aggregation of the product of the context attribute score and the context attribute weight for each context attribute associated with each context dimension. Additionally, the transition value assessment computing apparatus 12 obtains an overall weight for each context dimension. The overall weights can be percentage values totaling one hundred percent and indicating a relative importance with respect to the context of the application transition. In this example, the transition value assessment computing apparatus 12 generates the transition context index value as an aggregation of the product of the context dimension weighted score and overall weight for each context dimension. One or more of the context attribute score, context attribute weight, context dimension weighted score, overall weight, or transition context index value can be input by a user of, and/or calculated by, the client computing device 14 and communicated to the transition value assessment computing apparatus 12.

In step 202, the transition value assessment computing apparatus 12 generates a transition enabler overall score for each of a plurality of transition enablers associated with each of a plurality of focus areas. The transition enablers represent specific capabilities within the transition process provided by the new service provider in order to add value to the transition. Each focus area represents a set of capabilities. Together, the focus areas represent the specific areas or portions of the transition process in which the new service provider utilizes its capabilities in order to add value to the transition. Exemplary transition enablers associated with a respective knowledge transfer focus area are shown in Table 2, although other number and types of transition enablers can be used.

TABLE 2

| | Transition | | Ease | Cost | Risk | Overall |
|---|---|---|---|---|---|---|
| Focus Areas | Enablers | Weight | Score | Score | Score | Score |
| Portfolio | Enabler-1 | | | | | |
| Analysis | Enabler-2 | | | | | |
| Transition | Enabler-3 | | | | | |
| Planning & | Enabler-4 | | | | | |
| Tracking | | | | | | |
| Knowledge | Collaboration & | 20% | 8 | 6 | 5 | 1.92 |
| Transfer | Knowledge | | | | | |
| | Management | | | | | |
| | Tools and | | | | | |
| | Accelerators | | | | | |
| | Transition | 20% | 7 | 4 | 2 | 0.56 |
| | methodology & | | | | | |
| | Knowledge | | | | | |
| | score card | | | | | |
| | Application | 30% | 9 | 6 | 3 | 1.62 |
| | mining | | | | | |
| | solution & | | | | | |
| | Support tool data | | | | | |
| | to extract | | | | | |
| | information | | | | | |
| | Reference | 30% | 3 | 7 | 8 | 1.89 |
| | Domain | | | | | |
| | Process models | | | | | |
| | & Domain | | | | | |
| | Experts in Team | | | | | |
| Governance | Enabler-5 | | | | | |
| | Enabler-6 | | | | | |
| | Enabler-7 | | | | | |
| Collabo- | Enabler-8 | | | | | |
| ration | | | | | | |

In this example, the transition value assessment computing apparatus 12 obtains a transition enabler weight, at least one transition enabler score, such as an ease of implementation score or a cost of implementation score, and a risk of failure score for each of the plurality of transition enablers. The transition enabler scores and/or weights can be determined by the new service provider and can be based in part on the context. Optionally, the weight associated with each transition enabler can indicate a relative importance of the transition enabler to the focus area. The scores can each be relative values on a one to ten scale, for example, and the weight values associated with each transition enabler can be percentage values totaling one hundred percent for each focus area, although other values and proportions can be used. In this example, the transition value assessment computing apparatus 12 determines a weighted overall transition enabler score based on the product of the score(s) and the weight for each transition enabler.

Optionally, the transition enabler scores are risk-adjusted transition enabler scores. Accordingly, the transition value assessment computing apparatus obtains a risk of failure score which can also be a relative value on a one to ten scale. In this example, the transition value assessment computing apparatus 12 determines a risk-adjusted transition enabler score for each transition enabler as the product of the weighted overall transition enabler score and a risk factor percentage corresponding to the risk of failure score. In this example, the overall scores shown in Table 2 for the knowledge transfer focus area transition enablers are risk-adjusted transition enablers scores generated based on the exemplary risk factor percentages corresponding to risk of failure scores shown in Table 3.

TABLE 3

| Avg. Risk of failure score | Risk Factor |
|---|---|
| 8 to 10 | 30% |
| 5 to 7 | 20% |
| 2 to 4 | 10% |
| <2 | 5% |

One or more of the transition enabler scores, weights, weighted overall scores, or risk of failure scores can be input by a user of, and/or calculated by, the client computing device 14 and communicated to the transition value assessment computing apparatus 12. Additionally, the score adjustment, based on the weights for example, of the transition enablers and/or any other variable can be formulated through statistical/mathematical methods including but not limited to sigmoid curve fitting, for example.

In step 204, a preprocessing module 26 of the transition value assessment computing apparatus 12 optionally preprocesses and/or performs an exploratory data analysis (EDA) on the transition enabler overall scores including applying at least one technique selected from variable selection, outlier identification, missing value identification, trend removal and transformation, or bucketing. One or more of the techniques can optionally reference historical data, including historical transition enabler scores, stored in a database in the memory 20, for example.

The variable selection technique can be used by the transition value assessment computing apparatus 12 to identify one or more transition enablers to be used, as described in detail below, or one or more transition enablers to be disregarded. The technique can include a stepwise regression analysis, principal component analysis, correlation analysis, Akaike information criteria (AIC) analysis, and/or a Bayesian information criteria (BIC) analysis.

Additionally, the variable selection technique can select a suitable surrogate for measuring a stated transition goal established by the client if the goal is not otherwise directly measurable. In one example, a client can establish a goal of completeness of knowledge transfer during the transition. Accordingly, the transition value assessment computing apparatus 12, during the variable selection process, can identify a surrogate of the percentage of tickets (or defects) fixed independently within the SLA as a measurable quantity corresponding to the level of knowledge transfer from the client to the new service provider. Accordingly, in this example, the level of knowledge transfer is reflected by the number of tickets fixed independently within the SLA.

By applying an outlier identification technique, the transition value assessment computing apparatus 12 can identify outliers in the transition enabler overall scores such as by using a scatter and/or probability plot. By applying a missing value identification technique, the transition value assessment computing apparatus 12 can replace any missing values in the transition enabler overall score data with estimated values obtained by applying an interpolation and/or extrapolation analysis, a model-based imputation analysis, and/or a genetic algorithm, for example.

Additionally, the transition value assessment computing apparatus 12 can apply a trend removal or transformation technique in order to check for normality of the transition enabler overall score data using a histogram, pie chart, and/or box plot, for example, or using one or more statistical techniques such as, but not limited to, a moving average or regression method. One or more transformations can be applied to the transition enabler overall score data when it is determined that the data is not normal, such as, but not limited to, a log transformation, exponential transformation, and/or box-cox transformation, for example. Optionally, the transition value assessment computing apparatus 12 further determines whether the transition enabler overall score data is stationary using a Durbin-Watson test or other correlation test, for example.

In order to prepare the transition enabler score data to be used with a Bayesian network or multinomial regression model, as described and illustrated in detail below, the transition value computing apparatus 12 optionally transforms the continuous data into discrete data associated with buckets or categories (e.g. low, medium, and high). Optionally one or more techniques such as three-sigma limits, five-sigma limits, or any other control limits can be applied to the transition enabler overall score data in order to categorize the data.

In step 206, a metrics statistical engine 28 of the transition value assessment computing apparatus 12 generates a plurality of transition metric values for at least one transition metric based on the plurality of transition enabler overall scores and at least one of historical data including at least historical transition metric data and/or domain expert information. The historical data can be stored in a database in the memory 20, for example, and can include relationships of transition enabler overall scores and transition metric values for prior transitions. In this example, each transition enabler is associated with a unique set of transition metrics which each represent efficiency and/or effectiveness measurements.

If historical data for one or more transition metrics associated with one or more of the transition enablers is not available, a surrogate transition metric and associated values can be used. Additionally, domain expert information can be used in place of the historical transition metric values. The domain expert information can be provided by a person with knowledge of prior transitions and can be qualitative, in which case the information can be translated to quantitative values such as by correlating the information with a relative number scale or range.

Accordingly, one or more of the transition metrics, shown in Table 4 as associated with the completeness of knowledge transfer transition impact value, can be associated with one or more of the transition enablers shown in Table 2, although any other transition metric(s), any other transition enablers(s) and any relationships between the transition metrics and transition enablers can be used.

TABLE 4

| Transition Impact Value | Transition Metrics |
|---|---|
| Completeness of | Percentage tickets re-opened after fix |
| Knowledge Transfer | Percentage of correct fix first time |
| | Percentage of work product with zero |
| | critical/major defects |
| | Percentage of requests deviated from estimated |
| | schedule |

In addition to the historical transition metric data, the historical data can include historical transition enabler overall score data and relationship information for the transition enablers and the transition metrics. In this example, the metrics statistical engine 26 is configured to apply a metrics statistical model to determine one or more likely transition metric values for one or more transition enablers. Accordingly, the metrics statistical engine 26 receives the transition enabler overall scores, as optionally preprocessed in step 204, and the historical data and/or domain expert information, including the transition metric data and outputs a plurality of likely transition metric values. The plurality of transition metric values are generated based on a comparison of the transition enabler scores to the historical data or domain expert information which can include a correlation between historical transition enabler overall score data and the historical transition metric data and/or domain expert information. The output of the metrics statistical engine 26 can be continuous, discrete, and/or probability value data.

In step 208, an impact statistical engine 30 of the transition value assessment computing apparatus 12 generates a plurality of transition impact values based on the transition context index value generated in step 200, the plurality of transition metric values generated in step 206, and historical data including at least historical transition impact value data. Optionally, the impact statistical engine 30 can generate the plurality of transition impact values based on the historical transition metric data instead of or in combination with the transition metric values generated in step 206. The historical data can be stored in a database in the memory 20, for example.

Each transition impact value is a measurable quantity associated with one or more transition metrics. Each transition impact value represents one or more client goals and/or objectives for the application transition. Exemplary client goals for a successful and efficient transition include reduction in client SME utilization, reduction in transition cost, reduction in transition risk, faster completion of transition, and completeness of knowledge transfer, although any other transition impact values can be used. In one example, the completeness of knowledge transfer transition impact can be associated with a plurality of transition metrics as shown in Table 4. In this example, the completeness of knowledge transfer transition impact can be represented by a measurable quantity, such as the percentage of tickets fixed independently within the SLA.

In this example, the impact statistical engine 30 is configured to apply an impact statistical model to determine a plurality of transition impact values. Accordingly, the impact statistical engine 30 receives the transition context index value generated in step 200, the plurality of transition metric values generated in step 206, and the historical transition impact values and outputs transition impact values for each of a plurality of transition impacts. Optionally, one or more of the transition context attribute scores or the transition context index value is preprocessed as described earlier with respect to step 204. The plurality of likely transition impact values are generated based on a comparison of the transition context index value to the historical data which can include a functional relation between historical transition context index values, historical transition metric data, and the historical transition impact value data. The output of the impact statistical engine 30 can be continuous, discrete, and/or probability value data.

In step 210, the hierarchical statistical engine 32 of the transition value assessment computing apparatus 12 generates at least one likely transition impact value for each transition impact based at least on the plurality of transition metric values generated in step 206, the plurality of transition impact values generated in step 208, and the transition context index value generated in step 200. The hierarchical statistical engine 32 can apply a hierarchical statistical model, such as but not limited to a tree-based model, based on transition metric and transition impact values output by the metrics statistical engine 26 and impact statistical engine 30, respectively, as well as transition context index value(s) generated in step 200.

In step 212, the transition value assessment computing apparatus 12 outputs the at least one likely transition impact value such as on a display device and/or by sending the at least one likely transition impact value to the client computing device 14 using the network interface 22 and the communication network 16.

Optionally, one or more of the statistical models or the preprocessed transition enabler and/or context data can be displayed using a visualization module 36 of the transition value assessment computing apparatus 12. The visualization module 36 can be configured to output, such as to a display device or by sending to the client computing device 14, different types of graphs, plots, and/or charts, for example, to allow a user to observe the data. In one example, the results of applying and/or fitting the statistical models in steps 206, 208, and 210 can be displayed to allow a user to observe the fit of the model to the data. In another example, the output of the validation module 34 can be displayed by the visualization module 36 to allow a user to observe the various plots and diagnostic measure output representing the validity of the data. Thereby, a user can observe and further determine the relationship between the different variables (e.g. transition context index value, transition enablers, transition metrics, and transition impact values).

In step 214, the transition value assessment computing apparatus 12 determines whether there are any additional applications included in the scope of the transition. When it is determined that at least one application has not been analyzed by the transition value assessment computing apparatus 12, the Yes branch is taken to step 200 such that the transition value is assessed for each application within the scope of the transition, as described earlier with respect to steps 200-212.

When it is determined that steps 200-212 have been performed with respect to applications within the scope of the transition, the No branch is taken to step 216. In step 216, the transition value assessment computing apparatus 12 obtains a group goal value for each of a plurality of transition impact value categories for each of a plurality of groups of applications wherein the groups include one or more applications sharing a transition context index value or a range of transition context index values. In this example, each of the applications within the scope of the transition are grouped based on their respective transition context index values, such as shown in Table 5, for example.

TABLE 5

| | Overall | | | | | | | |
|---|---|---|---|---|---|---|---|---|
| | Context | | App | | | | | Avg. |
| | Index | | Overall | Avg. Client | | | | Percentage |
| | Value | | Context | SME | Avg. | Avg. | Avg. | Completeness |
| Group | Range | App. | Value | Utilization | Cost | Risk | Time | of KT |
| G1 | 8 to 10 | A1 | 8 | V High | Low- | High | Low | Med-High |
| | | A2 | 8 | | Med | | | |
| | | A3 | 9 | | | | | |
| G2 | 5 to 7 | A4 | 6 | Med | V | V | High | Low-Med |
| | | | | | Low | High | | |

In step 218, the transition value assessment computing apparatus 12 outputs a transition value dashboard including a difference between an average of the determined likely transition impact values for each of the one or more applications for each group and the group goal value. In one example, the client can set a goal of completeness of knowledge transfer such that ninety percent of the tickets are fixed within the SLA. In the example shown in Table 5, the likely transition impact value for the completeness of knowledge transfer transition impact value indicates, for group G1, a “Med-High” value with respect to the ninety percent goal, and for group G2, a “Low-Med” value with respect to the ninety percent goal. The “Med-High” value can correspond to five to ten percent greater than the group goal value and the “Low-Med” value can correspond to five to ten percent lower than the group goal value. Other indicators can be used to represent the difference between the predicted transition impact values determines in step 210 and the group goal value set by the client.

Optionally, the transition value assessment computing apparatus 12 can obtain a goal value for one or more transition impacts for each application instead of a group level goal. In this example, the transition value assessment computing apparatus 12 outputs a transition value dashboard that includes the difference between the determined likely transition impact values for each application and the direct goal value for each application within the scope of the transition.

Additionally, in some examples, confidence level(s) can be determined indicating the likelihood the determined likely transition impact value(s) will reach or exceed the goal value(s) for each application. The confidence level can be included in the dashboard and can be determined based on a quantitative model such as, but not limited to, a Euclidian distance based computation or a percent match model. These models can also be adaptive and updated whenever the new measured and/or determined information becomes available.

With the transition value dashboard a new service provider can make more informed decisions regarding transition planning and risk mitigation. As the transition progresses, the predicted values for one or more of the measurable variables, such as the transition metrics for example, can be replaced by the actual measured values. As the measurable values are determined, they can be obtained by the transition value assessment computing apparatus 12 which can store the values in the database in the memory 20 and thereby update the stored historical data. Additionally each of the statistical models and the output of the transition value assessment apparatus 12 can be adaptive and updated whenever new data is generated and/or measured.

Accordingly, the transition value assessment computing apparatus 12 can become more intelligent over time with respect to fitting the various statistical models and predicting likely transition impact values. Post transition, the predicted values for one or more of the measurable variables, such as the transition impact values, can be replaced by the actual measured values. Based on a comparison of the predicted value and the actual value delivered, corrective action can be taken during the steady state phase, if necessary.

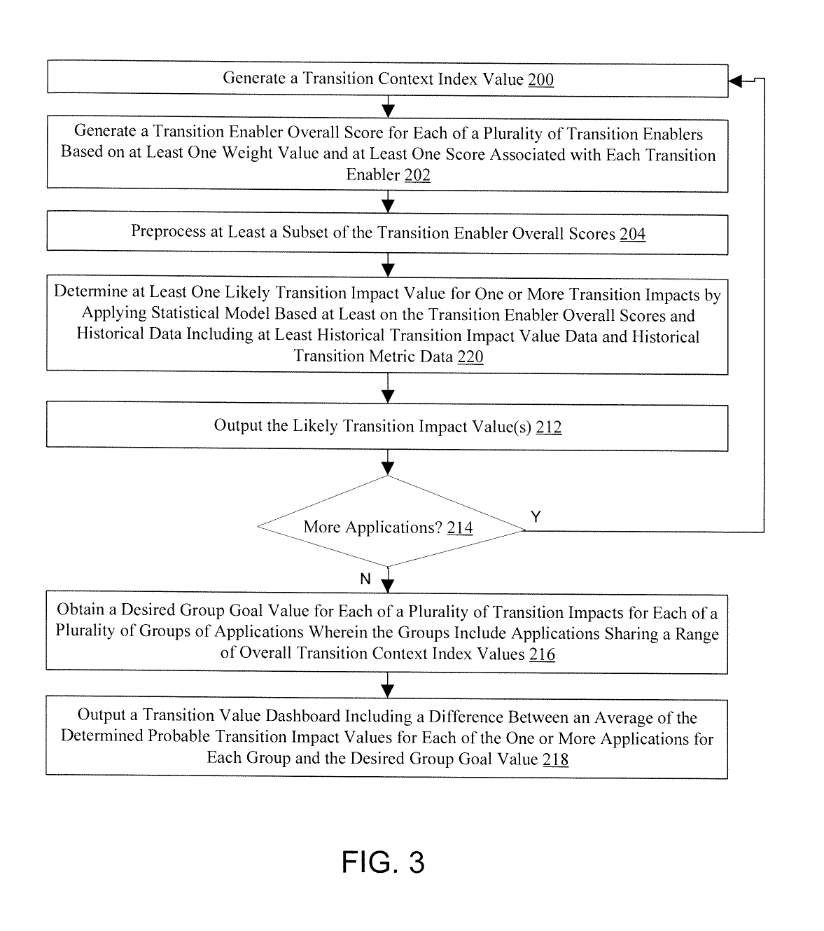

An exemplary method for assessing transition value using at least a hierarchical engine will now be described with reference to FIGS. 1 and 3. In this particular example, steps 200-204 and 212-218 can proceed as described and illustrated earlier. At step 220, the hierarchical statistical engine 32 of the transition value assessment computing apparatus 12 determines at least one likely transition impact value for one or more transition impacts by applying a statistical model based at least on the transition enabler overall scores and historical data including at least historical transition impact value data and historical transition metric data. In this example, the hierarchical statistical engine can be a probabilistic network structured modeling engine configured to input at least the transition enabler overall scores generated in step 202 and output likely transition impact values.

While there is no direct relationship between the transition enablers and the transition impacts, the hierarchical statistical engine integrates the two levels of relationships (transition enablers to transition metrics and transition metrics to transition impacts) by applying a hierarchical statistical model, such as, but not limited to, a tree-based model, based on the historical data. In some examples, the hierarchical statistical engine 32 applies the hierarchical statistical model based on historical transition metric, transition impact values, and/or transition context index value. Additionally, as the hierarchical statistical engine 32 can be configured to input transition enabler overall scores and output likely transition impact values, one or more of the transition enabler overall scores can be modified to determine potential effect on transition impact value(s) and thereby inform transition planning and improve the delivered transition value. Optionally, perturbation-based methods can be used to validate the performance of the hierarchical statistical engine.

The statistical model(s) applied by one or more of the metrics statistical engine 26, impact statistical engine 28, or the hierarchical statistical engine 30 can be a linear regression model, a nonlinear regression model, a clustered technique model, a Bayesian network, a neural network, a decision tree, or a meta heuristic model, although other numbers and types of models can be used.

Optionally, one or more of the statistical models can be validated by a validation module 34 of the transition value assessment computing apparatus 12. In order to validate one or more of the statistical models, the validation module 34 can be configured to generate one or more of a residual plot, a regression plot, an outlier plot and/or one or more diagnostic measures including mean square error, mean absolute deviation error, entropy measure, chi square test, Anderson-Darling test, or perturbation methods, for example, although other plots and/or diagnostic measure can be used. The plots and/or diagnostic measure generated by the validation module, and optionally output by the transition value assessment computing apparatus 12, are determined based on the type statistical model selected by the engines 26, 28, and 30.

By this technology, a new service provider can leverage historical data to predict value to be delivered to a client for each application within the scope of a transition of multiple applications. Using overall scores for a plurality of transition enablers and a transition context index value, values for transition metrics can be generated. With the transition metrics, values for transition impact values corresponding to client goals can be predicted. As a result, the new service provider can articulate to a client a value assessment for each application based on the context of the application and/or transition and an identified set of transition enablers representing capabilities of the new service provider, as measured using an identified set of corresponding transition metrics.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for assessing transition value, comprising:
generating, with the transition value assessment computing apparatus, a transition enabler overall score for each of a plurality of transition enablers based on at least one weight value and at least one score associated with each transition enabler;
generating, with the transition value assessment computing apparatus, a hierarchical statistical model based at least on the transition enabler overall scores and at least one of transition metric values, transition impact values, a transition context index value, or domain expert information;
determining, with the transition value assessment computing apparatus, at least one transition impact value based on the hierarchical statistical model; and
outputting, with the transition value assessment computing apparatus, the at least one transition impact value.

2. The method of claim 1 further comprising:
generating, with the transition value assessment computing apparatus, a metrics statistical model based at least on the transition enabler overall scores and at least one of the historical transition metric data or the domain expert information;
determining, with the transition value assessment computing apparatus, a plurality of transition metric values based on the metrics statistical model;
generating, with the transition value assessment computing apparatus, an impact statistical model based at least on the plurality of transition metric values and the transition context index value; and
wherein the transition metric values include the plurality of transition metric values determined based on the metrics statistical model and the transition impact values include a plurality of transition impact values determined based on the impact statistical model.

3. The method of claim 2 further comprising:
obtaining, with the transition value assessment computing apparatus, a context attribute weight value and a context attribute score for each of the plurality of context attributes wherein each of the plurality of context attributes is associated with at least one of a plurality of context dimensions;
obtaining, with the transition value assessment computing apparatus, an overall weight value for each of the plurality of context dimensions; and
generating, with the transition value assessment computing apparatus, the transition context index value based on each of the context attribute weight values, context attribute scores, and overall weight values.

4. The method of claim 1 further comprising generating, with the transition value assessment computing apparatus, at least one of the transition metric values, the transition impact values, or the transition context index value based on historical data.

5. The method of claim 1 wherein the at least one score associated with each transition enabler is selected from one or more of an ease of implementation score, a cost of implementation score, or a risk of failure score and wherein the risk of failure score is associated with a risk factor.

6. The method of claim 2 further comprising, prior to generating, with the transition value assessment computing apparatus, any of the statistical models:
preprocessing, with the transition value assessment computing apparatus, the transition enabler overall scores; or
performing, with the transition value assessment computing apparatus, an exploratory data analysis (EDA) including applying at least one technique selected from variable selection, outlier identification, missing value identification, trend removal and transformation, or bucketing.

7. The method of claim 2 wherein one or more of the statistical models is of a type selected from a linear regression model, a nonlinear regression model, a clustered technique model, a Bayesian network, a neural network, or a meta heuristic model.

8. The method of claim 7 further comprising validating, with the transition value assessment computing apparatus, one or more of the statistical models including generating, based on the type of model, one or more of a residual plot, a regression plot, an outlier plot, or one or more diagnostic measures selected from mean square error, mean absolute deviation error, entropy measure, chi square test, Anderson-Darling test, or perturbation methods.

9. The method of claim 1 further comprising:
obtaining, with the transition value assessment computing apparatus, a group goal value for each of the plurality of transition impacts for each of a plurality of groups of applications wherein the groups include one or more applications sharing a range of transition context index values; and
outputting, with the transition value assessment computing apparatus, a transition value dashboard including a difference between one or more of the determined transition impact values for each of the one or more applications for each group and the group goal value.

10. A non-transitory computer readable medium having stored thereon instructions for assessing transition value comprising machine executable code which when executed by a processor, causes the processor to perform steps comprising:
generating a transition enabler overall score for each of a plurality of transition enablers based on at least one weight value and at least one score associated with each transition enabler;
generating a hierarchical statistical model based at least on the transition enabler overall scores and at least one of transition metric values, transition impact values, a transition context index value, or domain expert information;
determining at least one transition impact value based on the hierarchical statistical model; and
outputting the at least one transition impact value.

11. The medium of claim 10 further having stored thereon instructions that when executed by the processor cause the processor to perform steps further comprising:
generating a metrics statistical model based at least on the transition enabler overall scores and at least one of the historical transition metric data or the domain expert information;
determining a plurality of transition metric values based on the metrics statistical model;
generating an impact statistical model based at least on the plurality of transition metric values and the transition context index value; and
wherein the transition metric values include the plurality of transition metric values determined based on the metrics statistical model and the transition impact values include a plurality of transition impact values determined based on the impact statistical model.

12. The medium of claim 11 further having stored thereon instructions that when executed by the processor cause the processor to perform steps further comprising:
obtaining a context attribute weight value and a context attribute score for each of the plurality of context attributes wherein each of the plurality of context attributes is associated with at least one of a plurality of context dimensions;
obtaining an overall weight value for each of the plurality of context dimensions; and
generating the transition context index value based on each of the context attribute weight values, context attribute scores, and overall weight values.

13. The medium of claim 10 further having stored thereon instructions that when executed by the processor cause the processor to perform steps further comprising generating at least one of the transition metric values, the transition impact values, or the transition context index value based on historical data.

14. The medium of claim 10 wherein the at least one score associated with each transition enabler is selected from one or more of an ease of implementation score, a cost of implementation score, or a risk of failure score and wherein the risk of failure score is associated with a risk factor.

15. The medium of claim 11 further having stored thereon instructions that when executed by the processor cause the processor to perform steps further comprising, prior to generating any of the statistical models:
preprocessing the transition enabler overall scores; or
performing an exploratory data analysis (EDA) including applying at least one technique selected from variable selection, outlier identification, missing value identification, trend removal and transformation, or bucketing.

16. The medium of claim 10 wherein one or more of the statistical models is of a type selected from a linear regression model, a nonlinear regression model, a clustered technique model, a Bayesian network, a neural network, or a meta heuristic model.

17. The medium of claim 16 further having stored thereon instructions that when executed by the processor cause the processor to perform steps further comprising validating one or more of the statistical models including generating, based on the type of model, one or more of a residual plot, a regression plot, an outlier plot, or one or more diagnostic measures selected from mean square error, mean absolute deviation error, entropy measure, chi square test, Anderson-Darling test, or perturbation methods.

18. The medium of claim 10 further having stored thereon instructions that when executed by the processor cause the processor to perform steps further comprising:
obtaining a group goal value for each of the plurality of transition impacts for each of a plurality of groups of applications wherein the groups include one or more applications sharing a range of transition context index values; and
outputting a transition value dashboard including a difference between one or more of the determined transition impact values for each of the one or more applications for each group and the group goal value.

19. An apparatus for assessing transition value, comprising:
a processor coupled to a memory and configured to execute programmed instructions stored in the memory comprising:
generating a transition enabler overall score for each of a plurality of transition enablers based on at least one weight value and at least one score associated with each transition enabler;
generating a hierarchical statistical model based at least on the transition enabler overall scores and at least one of transition metric values, transition impact values, a transition context index value, or domain expert information;
determining at least one transition impact value based on the hierarchical statistical model; and
outputting the at least one transition impact value.

20. The apparatus of claim 19 wherein the processor is further configured to execute programmed instructions stored in the memory further comprising:
generating a metrics statistical model based at least on the transition enabler overall scores and at least one of the historical transition metric data or the domain expert information;
determining a plurality of transition metric values based on the metrics statistical model;
generating an impact statistical model based at least on the plurality of transition metric values and the transition context index value; and
wherein the transition metric values include the plurality of transition metric values determined based on the metrics statistical model and the transition impact values include a plurality of transition impact values determined based on the impact statistical model.

21. The apparatus of claim 20 wherein the processor is further configured to execute programmed instructions stored in the memory further comprising:
obtaining a context attribute weight value and a context attribute score for each of the plurality of context attributes wherein each of the plurality of context attributes is associated with at least one of a plurality of context dimensions;
obtaining an overall weight value for each of the plurality of context dimensions; and
generating the transition context index value based on each of the context attribute weight values, context attribute scores, and overall weight values.

22. The apparatus of claim 19 wherein the processor is further configured to execute programmed instructions stored in the memory further comprising generating at least one of the transition metric values, the transition impact values, or the transition context index value based on historical data.

23. The apparatus of claim 19 wherein the at least one score associated with each transition enabler is selected from one or more of an ease of implementation score, a cost of implementation score, or a risk of failure score and wherein the risk of failure score is associated with a risk factor.

24. The apparatus of claim 20 wherein the processor is further configured to execute programmed instructions stored in the memory further comprising, prior to generating any of the statistical models:
preprocessing the transition enabler overall scores; or
performing an exploratory data analysis (EDA) including applying at least one technique selected from variable selection, outlier identification, missing value identification, trend removal and transformation, or bucketing.

25. The apparatus of claim 19 wherein one or more of the statistical models is of a type selected from a linear regression model, a nonlinear regression model, a clustered technique model, a Bayesian network, a neural network, or a meta heuristic model.

26. The apparatus of claim 25 wherein the processor is further configured to execute programmed instructions stored in the memory further comprising validating one or more of the statistical models including generating, based on the type of model, one or more of a residual plot, a regression plot, an outlier plot, or one or more diagnostic measures selected from mean square error, mean absolute deviation error, entropy measure, chi square test, Anderson-Darling test, or perturbation methods.

27. The apparatus of claim 10 wherein the processor is further configured to execute programmed instructions stored in the memory further comprising:
obtaining a group goal value for each of the plurality of transition impacts for each of a plurality of groups of applications wherein the groups include one or more applications sharing a range of transition context index values; and
outputting a transition value dashboard including a difference between one or more of the transition impact values for each of the one or more applications for each group and the group goal value.
